(19) United States
(12) Patent Application Publication
(10) Pub. No.: US 2024/0250821 A1
(43) Pub. Date: Jul. 25, 2024

(54) SECURE METERING FOR HYPERCONVERGED INFRASTRUCTURES

(71) Applicant: VMware, Inc., Palo Alto, CA (US)

(72) Inventors: Yang YANG, Shanghai (CN); Wenguang WANG, Santa Clara, CA (US); Jin FENG, Shanghai (CN); Wei ZHENG, Shanghai (CN)

(21) Appl. No.: 18/298,657

(22) Filed: Apr. 11, 2023

(30) Foreign Application Priority Data
Jan. 20, 2023 (WO) PCT/CN2023/000021

(51) Int. Cl. H04L 9/32; G06F 9/455

(52) U.S. Cl. CPC H04L 9/3213; G06F 9/45558; G06F 2009/45583; G06F 2009/45595

(57) ABSTRACT

Solutions for secure metering of hyperconverged infrastructures are disclosed. Examples include: receiving a security token; accessing a secondary storage (e.g., cold storage, backups) using the security token; determining usage data for the secondary storage; generating a first message digest for a combination of the usage data and the security token; and transmitting, to a metering server, the usage data and the first message digest. In some examples, the combination of the usage data and the security token comprises a concatenation of the usage data and the security token. In some examples, the metering server requests verification usage data from the secondary storage, generates a second message digest for a combination of the verification usage data and the security token, and compares the first message digest with the second message digest. Examples do not persist the security token on customer premises. Examples leverage the usage data to optimize the secondary storage.

### BACKGROUND

Converged infrastructure (CI) is a hardware-based approach to management of different servers, networking, and multiple storage solutions. Hyperconverged infrastructure (HCI) is a software-based approach to converging storage and processes, leveraging software to produce a CI solution from disparate building blocks. HCI implementations often use a metering service. Metering enables consumption-based metrics even while a customer has access to potentially significant resources.

Some HCI implementations may use block storage for primary storage and an object storage service for secondary storage (e.g., cold storage and/or backups). Because usage data of certain resources, such as storage, is used for metering, it is important that the usage data can be trusted. However, since the usage data is self-reported from servers located across a network from a metering server, a mechanism for determining trust in the usage data is needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for secure metering of hyperconverged infrastructures. Examples include: receiving a security token: accessing a secondary storage using the security token: determining usage data for the secondary storage; generating a first message digest for a combination of the usage data and the security token; and transmitting, to a metering server, the usage data and the first message digest. In some examples, the combination of the usage data and the security token comprises a concatenation of the usage data and the security token. In some examples, the metering server requests verification usage data from the secondary storage, generates a second message digest for a combination of the verification usage data and the security token, and compares the first message digest with the second message digest. Examples do not persist the security token on customer premises.

### BRIEF DESCRIPTION OF THE DRAWINGS

The present description will be better understood from the following detailed description read in the light of the accompanying drawings, wherein:

FIG. 1 illustrates an example architecture that advantageously provides for secure metering of a hyperconverged infrastructure (HCI):

FIG. 2 illustrates further detail for an example of an architecture that may be used in an example architecture such as that of FIG. 1:

FIG. 3 illustrates a flowchart of exemplary operations associated with secure metering of HCIs, as may be performed using an example architecture such as that of FIG. 1;

FIG. 4 illustrates a message sequence diagram of example messages that may be sent used during example operations, such as those of FIG. 3;

FIGS. 5-8 illustrates additional flowcharts of exemplary operations that may be performed in support of, and along with, example operations such as those of FIG. 3;

FIG. 9 illustrates another flowchart of exemplary operations associated with an example architecture such as that of FIG. 1: and

FIG. 10 illustrates a block diagram of an example computing apparatus that may be used as a component of an example architecture such as that of FIG. 1.

Any of the figures may be combined into a single example or embodiment.

### DETAILED DESCRIPTION

Aspects of the disclosure provide solutions for secure metering of hyperconverged infrastructures (HCIs). Examples include: receiving a security token; accessing a secondary storage (e.g., cold storage and/or backups) using the security token; determining usage data for the secondary storage: generating a first message digest for a combination of the usage data and the security token: and transmitting, to a metering server, the usage data and the first message digest. In some examples, the combination of the usage data and the security token comprises a concatenation of the usage data and the security token. In some examples, the metering server requests verification usage data from the secondary storage, generates a second message digest for a combination of the verification usage data and the security token, and compares the first message digest with the second message digest. Examples do not persist the security token on customer premises. Examples use the usage data to adjust a parameter of the secondary storage for optimization, such as by using a machine learning (ML) model.

Secure metering is a way of obtaining usage data (e.g., amount of usage, times/dates of usage, user identity, etc.) for a resource in a manner that the entity that controls the resource and/or billing for usage of the resource is able to trust the usage data. For example, with physical utilities, secure metering uses tamper-resistant meters, and for cloud resources, secure metering uses tamper-evident reporting mechanisms. Aspects of the disclosure provide a tamper-evident reporting mechanism that uses a cryptographic solution to enable the resource owner/controller to identify whether the user has altered the usage data.

A security token, as used be examples of the disclosure, comprises a unique bit string (e.g., sequence of binary values 1 and 0) that, when appended to the usage data and hashed, creates a second unique bit string. The unique bit string of the security token is selected such that, when known to the resource owner/controller, reproduction of the second unique bit string is nearly trivial, whereas attempting to forge a duplicate of the second unique bit string, with altered usage data and without knowing the unique bit string of the security token, is computationally challenging. This approach discourages the user of the resource, who self-reports the usage data, from attempting to alter the usage data, because a successful forgery that would escape detection by the resource owner/controller (with nearly trivial effort) is overly burdensome.

One way to produce this second unique bit string is to concatenate the usage data and the unique bit string of the security token, and pass that combination through a hash function to produce a message digest. A message digest is a numeric representation of the contents of a message or digital file, computed by a one-way function, such as a hash function or other cryptographically secure one-way function. A cryptographically secure one-way function is a function for which an output is easy to compute, when given an input, but reversing the function in order to determine an unknown input that produces a given output, is computationally infeasible. A message digest, sometimes referred to as a hash value, is therefore a digital fingerprint of a message or digital file.

Aspects of the disclosure are able to reduce the number of computing resources needed, thereby reducing power consumption, by improving efficiency of HCI implementations. This is accomplished by using a scheme that imparts trust to self-reported usage data. Trusted data is actionable, whereas relying on data for which trust is not established risks system crashes and/or other poor performance. Trust is imparted by at least generating a message digest for a combination of usage data and a security token. Thus, aspects of the disclosure provide a practical, useful result to solve a technical problem in the domain of computing.

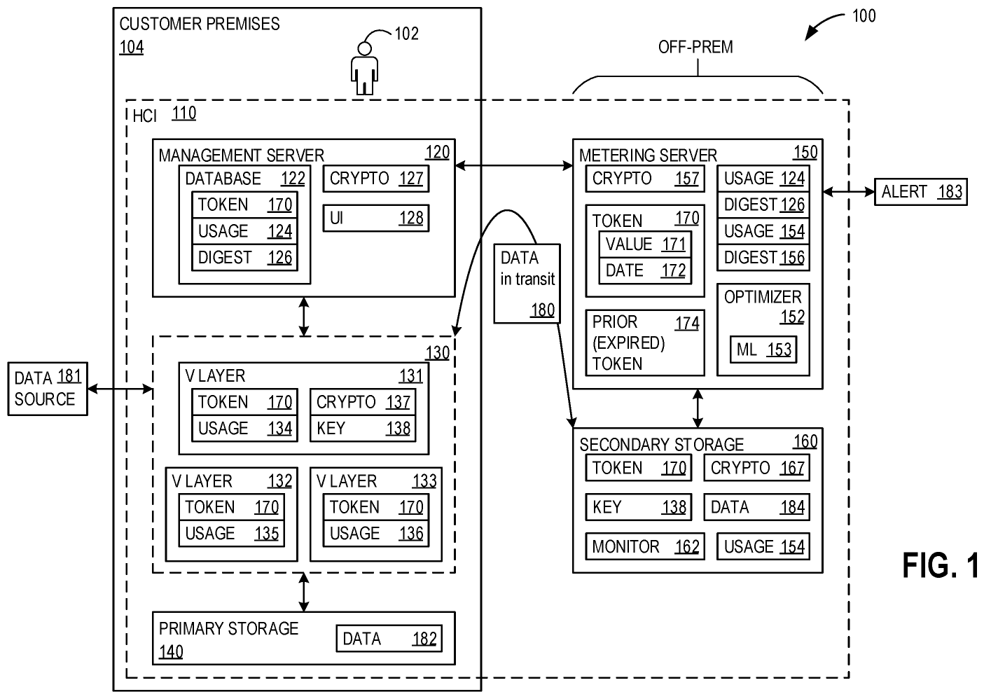

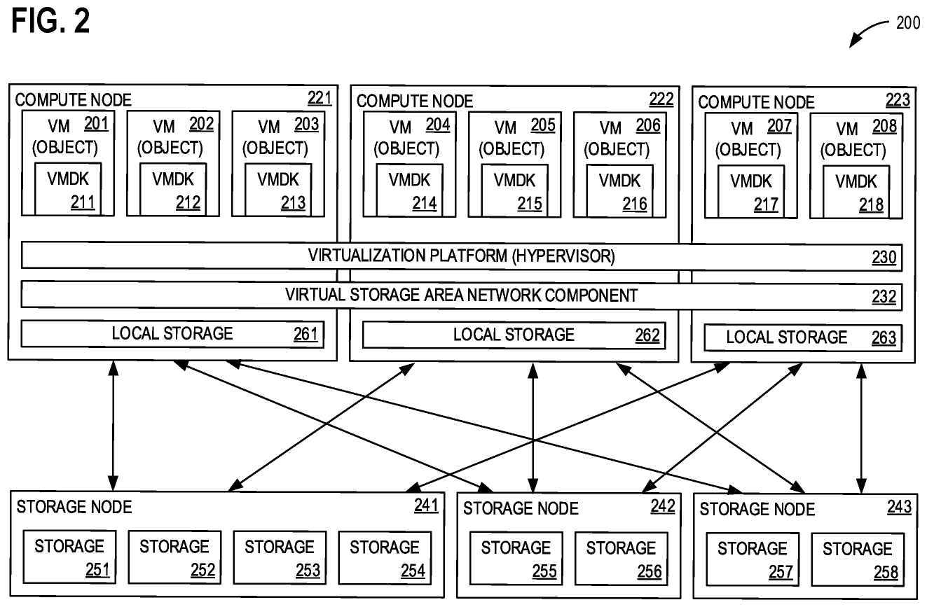

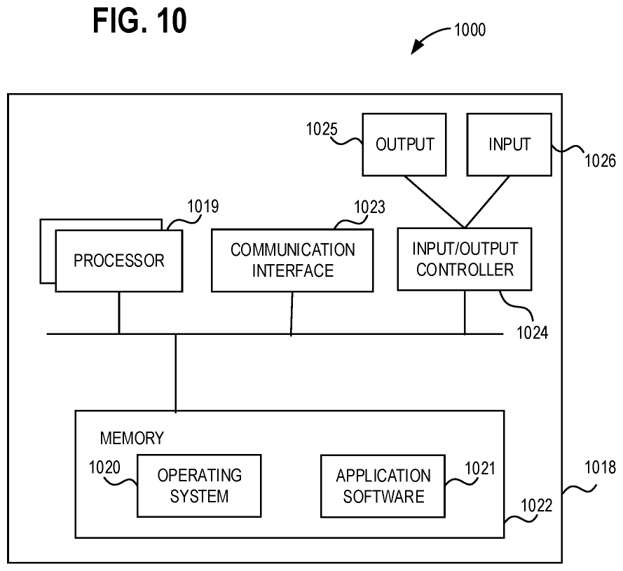

FIG. 1 illustrates an example architecture 100 that advantageously provides for secure metering of an HCI 110. Components of HCI 110, for example a management server 120, a virtualization component 130, a primary storage 140, a metering server 150, and a secondary storage 160, may be implemented on one or more computing apparatus 1018 of FIG. 10, and/or using a virtualization architecture 200 as is illustrated in FIG. 2.

HCI 110 spans components located on a customer premises 104 and off-prem components. Management server 120, virtualization component 130, and primary storage 140 are typically (although not necessarily) on-prem, whereas metering server 150 and secondary storage 160 are off-prem. Primary storage 140 is typically used mainly for hot storage, and is typically faster and more expensive, while secondary storage 160 is typically used mainly for cold storage and backups. As a result, primary storage 140 uses block storage for better performance under virtualization component 130, while secondary storage 160 uses object storage, structured query language (SQL), and/or noSQL. In some examples, primary storage 140 uses file storage.

A user 102 interacts with HCI 110 using a virtualization management user interface (UI) 128, which is run by management server 120 in the illustrated example. User 102 is able to employ virtualization management UI 128 to monitor usage and performance of HCI 110 and its components. A management server database 122, managed by management server 120, stores metering data and data used in the management and operation of HCI 110. For example, management server database 122 stored a security token 170, usage data 124, and a message digest 126.

Security token 170 is used to access secondary storage 160, and in typical operations is passed by management server 120 to virtualization component 130 only once—unless virtualization component 130 requests security token 170 from management server 120 again as part of a recovery operation. As described in further detail below, usage data 124 may indicate the usage of secondary storage 160 by a single virtualization layer within virtualization component 130, such as a virtualization layer 131, or may indicate the aggregated usage of secondary storage 160 by all virtualization layers within virtualization component 130 that are using security token 170 to access secondary storage 160.

A cryptography module 127 generates message digest 126 using a combination of usage data 124 and security token 170 in a one-way function. For example, security token 170 may be used to salt usage data 124 for the input of the one-way function. Salting helps to ensure a unique message digest in the event that the base input is the same as the base input for another application of the one-way function (e.g., usage data 124 for a prior time period). For example, the base input is usage data 124 for the current time period and a prior time period). Security token 170 has at least a value 171 and, in the illustrated example, also has an expiration date 172. In an example, usage data 124 and security token 170 are both rendered into string variables, concatenated, and passed to a hash function. In one example, this is: message digest 126=hash {string(usage data 124)+string(security token value 171)}, although other schemes may also be used.

As an example, if usage data 124 is 123 gigabytes (GB), such that string(usage data 124) is “123000000000” and string(security token value 171) is “ABCD”, then message digest 126 is “73a7a4e426acf4a44ee50a63df0d51a4fe631025d4918fcfad665ebc3ad6abe2” for the one-way function being the SHA-256.

Metering server 150 generates security token 170 using a cryptography module 157 upon initial setup of HCI 110 and later, upon the expiration of, or imminent expiration of, a prior security token 174. This scheme ensures that a relatively fresh security token is available for accessing secondary storage 160, which improves security. Cryptography module 157 also validates message digest 126 by requesting verification usage data 154 directly from secondary storage 160, independently generating message digest 156 and comparing message digest 126 with message digest 156.

Cryptography module 157 matches the generation scheme for message digest 126 when independently generating message digest 156. For example, verification usage data 154 is combined with security token 170 the same way that usage data 124 is combined with security token 170, such as: message digest 156=hash {string(verification usage data 154)+string(security token value 171)}. If verification usage data 154 is the same as usage data 124, then message digest 156 matches message digest 126. If user 102 had tampered with usage data 124, for example in an attempt to reduce billing for the use of secondary storage 160, message digest 156 does not match message digest 126, and cryptography module 157 issues an alert 183. Alert 183 indicates the possibility that user 102 tampered with usage data 124, and may thus trigger remedial action.

An optimizer 152 adjusts HCI 110 to optimize efficiency, for example by increasing or decreasing the capacity of primary storage 140 and/or secondary storage 160, or changing other parameters, such as the size of objects used by secondary storage 160. Optimizer 152 is shown as having an ML model 153. As used herein ML includes artificial intelligence (AI).

In operation of HCI 110, data from a data source 181 comes into virtualization component 130 and is initially stored as stored data 182 in primary storage 140. Upon the need to back up some or all of stored data 182, or some of stored data 182 being designated as cold, virtualization component 130 accesses secondary storage 160 to send data 180 for inclusion within stored data 184. In some examples, data 180 flows from virtualization component 130, through management server 120 and metering server 150, to secondary storage 160. Additionally, when some of stored data 184 becomes hot again, virtualization component 130 accesses secondary storage 160 to retrieve data 180 for inclusion within stored data 182, using the same path. User 102 or data source 181 then reads data from primary storage 140, through virtualization component 130.

As illustrated, virtualization component 130 has three virtualization layers, virtualization layer 131, a virtualization layer 132, and a virtualization layer 133. Each of virtualization layers 131-133 abstracts processor, memory, storage and networking resources into multiple virtual machines (VMs). In some examples, each of virtualization layers 131-133 also includes a hypervisor.

Each of virtualization layers 131-133 uses security token 170 to access secondary storage 160. For example, data 180 passing to/from virtualization layer 131 from/to secondary storage 160 is encrypted using security token 170. In some examples, value 171 of security token 170 acts as an encryption key 138 to be used by a cryptography module 137 to encrypt/decrypt data 180. In some examples, cryptography module 137 hashes security token 170, possibly with salt, to generate encryption key 138.

In some examples, usage of secondary storage 160 is tracked separately for each of virtualization layers 131-133. In other examples, usage of secondary storage 160 is tracked only in the aggregate for all of virtualization layers 131-133 using security token 170 to access secondary storage 160. In the illustrated example, virtualization layer 131 has its own usage data 134, virtualization layer 132 has its own usage data 135, and virtualization layer 133 has its own usage data 136.

Because, in the illustrated example, each of virtualization layers 131-133 has a copy of security token 170, if one of virtualization layers 131-133 crashes and recovers, and is unable to retrieve security token 170 from management server 120, the affected virtualization layer will be able to retrieve a copy of security token 170 from one of its peer virtualization layers. Virtualization layers 132 and 133 are configured similarly as virtualization layer 131, including each having their own cryptography module and encryption key.

Secondary storage 160, which may be a cloud storage service, receives a copy of security token 170 from metering server 150, and uses a cryptography module 167 to generate its own copy of encryption key 138 to encrypt/decrypt data 180. Cryptography module 167 is able to generate the same encryption key as cryptography module 137 because both use security token 170. A usage monitor 162 monitors usage of secondary storage 160 by virtualization layers 131-133 and stores the information as verification usage data 154, which is sent to metering server 150 and at least virtualization layer 131. In various examples, verification usage data 154 indicates usage of secondary storage 160 by only virtualization layer 131, or other single one of virtualization layers 131-133, or the aggregate use by all of virtualization layers 131-133.

Examples of architecture 100 are operable with virtualized and non-virtualized storage solutions. FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

When objects are created, they may be designated as global or local, and the designation is stored in an attribute. For example, compute node 221 hosts objects 201, 202, and 203: compute node 222 hosts objects 204, 205, and 206: and compute node 223 hosts objects 207 and 208. Some of objects 201-208 may be local objects. In some examples, a single compute node may host 50, 100, or a different number of objects. Each object uses a VM disk (VMDK), for example VMDKs 211-218 for each of objects 201-208, respectively. Other implementations using different formats are also possible. A virtualization platform 230, which includes hypervisor functionality at one or more of compute nodes 221, 222, and 223, manages objects 201-208. In some examples, various components of virtualization architecture 200, for example compute nodes 221, 222, and 223, and storage nodes 241, 242, and 243 are implemented using one or more computing apparatus such as computing apparatus 1018 of FIG. 10.

Virtualization software that provides software-defined storage (SDS), by pooling storage nodes across a cluster, creates a distributed, shared data store, for example a storage area network (SAN). Thus, objects 201-208 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 252, and 254: storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-208 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201 and 202. Virtual SAN component 232 permits objects 201 and 202 to write incoming data from object 201 and incoming data from object 202 to storage nodes 241, 242, and/or 243, in part, by virtualizing the physical storage components of the storage nodes.

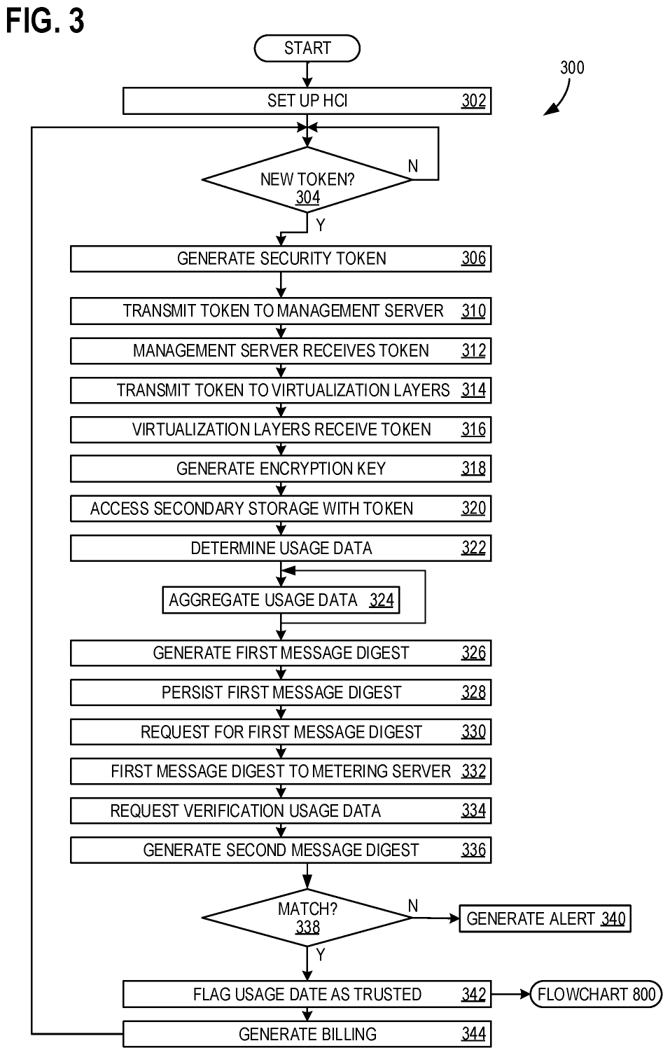

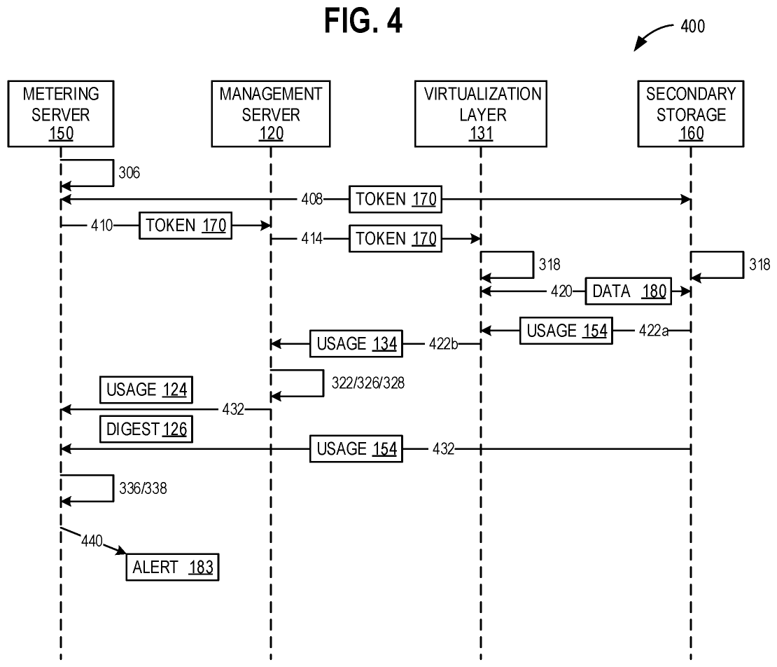

FIG. 3 illustrates a flowchart 300 of exemplary operations associated with secure metering of HCIs, as may be performed using examples of architecture 100. In some examples, the operations of flowchart 300 are performed by one or more computing apparatus 1018 of FIG. 10. FIG. 4 illustrates a message sequence diagram 400 of messages that may be used during the operations of flowchart 300. FIGS. 3 and 4 are separate examples but will be described together as a combined example for convenience. In some examples, security token 170 is not persisted in any component of HCI 110 at any time, in order to frustrate any potential surreptitious attempts by user 102 to learn the contents of security token 170, such as value 171.

Flowchart 300 commences with setting up HCI 110 in operation 302. In decision operation 304, cryptography module 157 determines whether a new security token is needed. This will be the case upon initial setup of HCI 110 and when prior security token 174 is expired or nearing expiration. If a new security token is needed, metering server 150 generates security token 170 in operation 306, using cryptography module 157. In some examples, however, secondary storage 160 instead generates a security token, which may be security token 170, or security token 170 is derived from a security token provided to metering server 150 by secondary storage 160. This is also shown as message 408 in message sequence diagram 400. Metering server 150 also sets expiration date 172 and associates it with security token 170, for example by indicating expiration date 172 within security token 170.

Security token 170 is transmitted to management server 120 in operation 310 by metering server 150 using a message 410. Management server 120 receives security token 170 in operation 312. Security token 170 may also be used by virtualization layers 132 and 133, unless each of those virtualization layer uses a unique security token.

In operation 314, management server 120 transmits security token 170 to virtualization layer 131, using a message 414. Message 414 also constitutes instruction, by management server 120, for virtualization layer 131 to use security token 170 for accessing secondary storage 160. Management server 120 also transmits security token 170 to virtualization layers 132 and 133 in operation 314. Virtualization layers 131-133 receive their copies of security token 170 in operation 316.

Virtualization layer 131 and secondary storage 160, along with other virtualization layers receiving security token 170, each generate their own copy of encryption key 138 with security token 170, in operation 318. Virtualization layer 131 then accesses secondary storage 160 using security token 170, in operation 320, using message 420. This may involve encrypting/decrypting data 180 that is sent by virtualization layer 131 to secondary storage 160 or retrieved by virtualization layer 131 from secondary storage 160. In some examples, this includes virtualization layer 131 moving data from primary storage 140 to secondary storage 160, such as moving cold data or creating a backup copy of stored data 182 from primary storage 140 on secondary storage 160.

In operation 322, management server 120 determines usage data 124 for secondary storage 160. In some examples, this comprises virtualization layer 131 receiving verification usage data 154 from secondary storage 160 as usage data 134 for at least virtualization layer 131, and passing usage data 134 to management server 120, which stores it as usage data 124 in management server database 122. This is shown as message 422a and message 422b in message sequence diagram 400. In some examples, usage data 124 indicates usage of secondary storage 160 by only virtualization layer 131, or usage data 124 indicates usage of secondary storage 160 by all of virtualization layers 131-133, and secondary storage 160 aggregates usage by all of virtualization layers 131-133 in verification usage data 154. In such examples, flowchart 300 moves from operation 322 directly to operation 326.

In some examples, usage data 124 indicates usage of secondary storage 160 by all of virtualization layers 131-133, but each of virtualization layers 131-133 reports only its own usage. In such examples, flowchart 300 moves from operation 322 to operation 324, in which management server 120 aggregates usage of secondary storage 160 by all of virtualization layers 131-133. In operation 326, management server 120, management server 120 generates message digest 126 for a combination of usage data 124 and security token 170. Management server 120 persists message digest 126 and usage data 124 in operation 328.

In operation 330, metering server 150 requests message digest 126 and usage data 124 from management server 120, and management server 120 responds by transmitting message digest 126 and usage data 124 to metering server 150 with a message 432, in operation 332. In operation 334, metering server 150 requests verification usage data 154 from secondary storage 160, and secondary storage 160 responds by transmitting verification usage data 154 to metering server 150 with a message 434.

Metering server 150 generates message digest 156 for a combination of verification usage data 154 and security token 170, in operation 336, and decision operation 338 compares message digest 126 with message digest 156 to determine whether they match. In the event that message digest 126 differs from message digest 156, metering server 150 generates alert 183 as message 440, in operation 340.

Otherwise, based on at least message digest 126 matching message digest 156, metering server 150 flags usage data 124 as trusted, in operation 342. Usage data 124 being trusted renders it actionable. For example, usage data 124 is leveraged for further refinement and optimization of HCI 110 using flowchart 800 of FIG. 8. Further, metering server 150 generates a billing for user 102, based on at least usage data 124, in operation 344. Flowchart 300 then returns to decision operation 304.

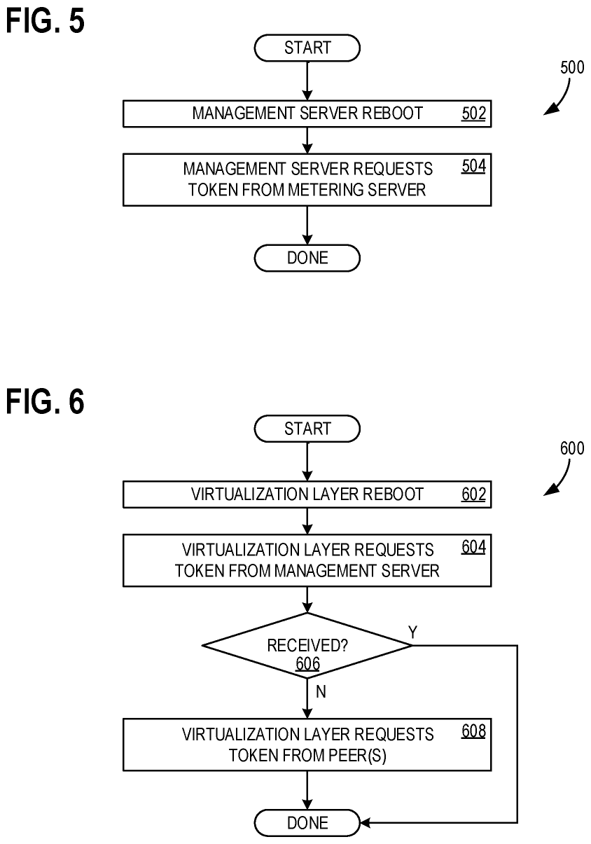

FIG. 5 illustrates a flowchart 500 of exemplary operations associated with architecture 100, and which may operate in parallel with flowchart 300. In some examples, the operations of flowchart 500 are performed by one or more computing apparatus 1018 of FIG. 10. Flowchart 500 commences with management server 120 rebooting in operation 502. Based on at least a reboot of management server 120, management server 120 requests security token 170 from metering server 150, in operation 504.

FIG. 6 illustrates a flowchart 600 of exemplary operations associated with architecture 100, and which may operate in parallel with flowchart 300. In some examples, the operations of flowchart 600 are performed by one or more computing apparatus 1018 of FIG. 10. Flowchart 600 commences with virtualization layer 131 rebooting, in operation 602. Based on at least a reboot of a virtualization layer 131, virtualization layer 131 requests security token 170 from management server 120, in operation 604.

Decision operation 606 determines whether virtualization layer 131 received security token 170 from management server 120. If not, then based on at least a failure to receive security token 170 from management server 120, virtualization layer 131 requests security token 170 from its peer virtualization layers, such as second virtualization layer 132, in operation 608.

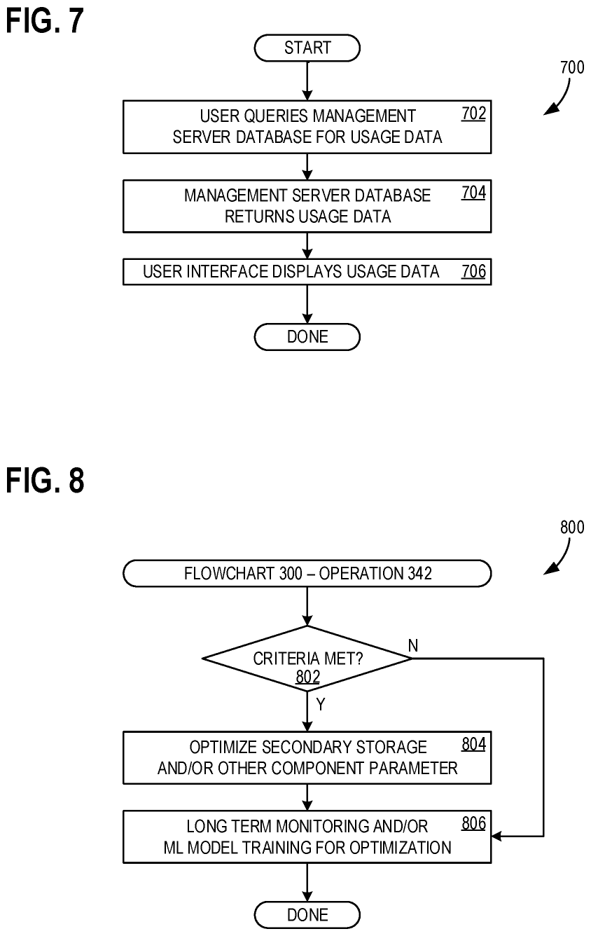

FIG. 7 illustrates a flowchart 700 of exemplary operations associated with architecture 100, and which may operate in parallel with flowchart 300. In some examples, the operations of flowchart 700 are performed by one or more computing apparatus 1018 of FIG. 10. Flowchart 700 commences with user 102 using virtualization management UI 128 to query management server database 122 for usage data 124 in operation 702. In operation 704, management server database 122 returns usage data 124 to virtualization management UI 128. Virtualization management UI 128 displays usage data 124 to user 102 in operation 706.

FIG. 8 illustrates a flowchart 800 of exemplary operations associated with architecture 100, and which follows operation 342 of flowchart 300. In some examples, the operations of flowchart 800 are performed by one or more computing apparatus 1018 of FIG. 10. Flowchart 800 commences with optimizer 152 performing decision operation 802 to determine whether usage data 124 meets criteria for adjusting a parameter of secondary storage 160, such as the capacity or object size, or a parameter of primary storage 140.

If so, based on at least message digest 126 matching message digest 156 which indicates trust in usage data 124, optimizer 152 uses usage data 124 to adjust a parameter of secondary storage 160 in operation 804. In some examples, this is accomplished by ML model 153. In operation 806, optimizer 152 monitors long-term performance, including usage data for secondary storage 160 and primary storage 140 and trains ML model 153 to further refine secondary storage 160 and primary storage 140 for efficiency.

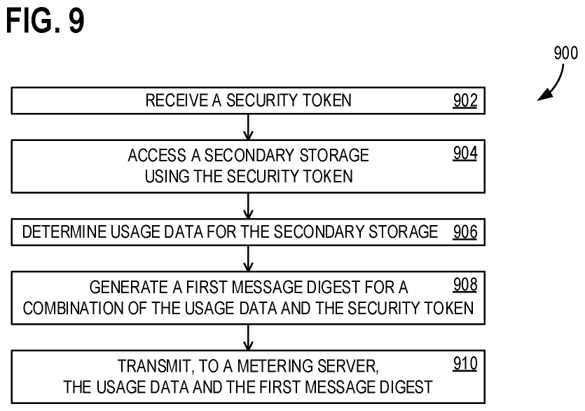

FIG. 9 illustrates a flowchart 900 of exemplary operations associated with architecture 100. In some examples, the operations of flowchart 900 are performed by one or more computing apparatus 1018 of FIG. 10. Flowchart 900 commences with operation 902, which includes receiving a security token. Operation 904 includes accessing a secondary storage using the security token. Operation 906 includes determining usage data for the secondary storage. Operation 908 includes generating a first message digest for a combination of the usage data and the security token. Operation 910 includes transmitting, to a metering server, the usage data and the first message digest.

### Additional Examples

An example method of secure metering of a hyperconverged infrastructure comprises: receiving a security token: accessing a secondary storage using the security token; determining usage data for the secondary storage: generating a first message digest for a combination of the usage data and the security token: and transmitting, to a metering server, the usage data and the first message digest.

An example computer system comprises: a processor: and a non-transitory computer readable medium having stored thereon program code executable by the processor, the program code causing the processor to: receive a security token: access a secondary storage using the security token: determine usage data for the secondary storage: generate a first message digest for a combination of the usage data and the security token: and transmit, to a metering server, the usage data and the first message digest.

An example non-transitory computer storage medium has stored thereon program code executable by a processor, the program code embodying a method comprising: receiving a security token: accessing a secondary storage using the security token, wherein accessing the secondary storage comprises moving data from a primary storage to the secondary storage, and wherein the primary storage comprises block storage and the secondary storage comprises an object storage service: determining usage data for the secondary storage: generating a first message digest for a combination of the usage data and the security token; and transmitting, to a metering server, the usage data and the first message digest.

Alternatively, or in addition to the other examples described herein, examples include any combination of the following:
requesting, by the metering server, verification usage data from the secondary storage;
generating a second message digest for a combination of the verification usage data and the security token;
comparing the first message digest with the second message digest;
based on at least the first message digest differing from the second message digest, generating an alert;
accessing the secondary storage comprises moving data from a primary storage to the secondary storage;
the primary storage comprises block storage;
the secondary storage comprises an object storage service;
not persisting, at a customer premises, the security token;
accessing the secondary storage using the security token comprises using the security token to encrypt data exchanged with the secondary storage;
the combination of the usage data and the security token comprises a concatenation of the usage data and the security token;
based on at least a reboot of a management server, requesting, by the management server, the security token from the metering server;
based on at least a reboot of a first virtualization layer, requesting, by the first virtualization layer, the security token from the management server;
based on at least a failure to receive the security token from the management server, requesting, by the first virtualization layer, the security token from a second virtualization layer;
based on at least the first message digest matching the second message digest, using the usage data to adjust, by an ML model, a parameter of the secondary storage;
generating, by the metering server, the security token;
based on at least an expiration date of a prior token, generating, by the metering server, the security token;
the security token comprises the token value and is associated with the expiration date;
the security token comprises the token value and the expiration date;
transmitting, by the metering server, to the secondary storage, the security token;
the secondary storage comprises a cloud storage service;
instructing, by the metering server, the secondary storage to use the security token for access by the first virtualization layer;
transmitting, by the metering server, to the management server, the security token;
receiving, by the management server, the security token;
transmitting, by the management server, to the first virtualization layer, the security token;
transmitting, by the management server, to the second virtualization layer, the security token;
generating the encryption key with the security token;
using the security token to encrypt the data exchanged with the secondary storage comprises encrypting the data exchanged with the secondary storage with the encryption key generated with the security token;
moving data from the primary storage to the secondary storage comprises moving cold data;
moving data from the primary storage to the secondary storage comprises creating a backup copy of the data from the primary storage on the secondary storage;
determining usage data for the secondary storage comprises receiving the usage data from the secondary storage;
receiving, by the first virtualization layer, the usage data for the secondary storage;
the usage data indicates usage of the secondary storage by only the first virtualization layer;
aggregating, by the management server, usage of the secondary storage by at least the first virtualization layer and the second virtualization layer;
the usage data indicates usage of the secondary storage by at least the first virtualization layer and the second virtualization layer;
the combination of the usage data and the security token comprises the usage data salted with at least the security token;
using a one-way function to generate the first message digest and the second message digest;
the first message digest comprises hash {string(usage data)+string(security token)};
persisting, by the management server, the first message digest and the usage data;
requesting, by the metering server, the first message digest and the usage data;
the verification usage data indicates usage of the secondary storage by only the first virtualization layer;
the verification usage data indicates usage of the secondary storage by at least the first virtualization layer and the second virtualization layer;
the second message digest comprises hash {string(verification usage data)+string(security token)};
based on at least the first message digest matching the second message digest, flagging the usage data as trusted; and
generating a billing based on at least the usage data.

### Exemplary Operating Environment

The present disclosure is operable with a computing device (computing apparatus) according to an embodiment shown as a functional block diagram 1000 in FIG. 10. In an embodiment, components of a computing apparatus 1018 may be implemented as part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hardcoded machine. Platform software comprising an operating system 1020 or any other suitable platform software may be provided on the computing apparatus 1018 to enable application software 1021 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1018. Computer-readable media may include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1022) is shown within the computing apparatus 1018, it will be appreciated by a person skilled in the art, that the storage may be distributed or located remotely and accessed via a network or other communication link (e.g. using a communication interface 1023). Computer storage media are tangible, non-transitory, and are mutually exclusive to communication media.

The computing apparatus 1018 may comprise an input/output controller 1024 configured to output information to one or more output devices 1025, for example a display or a speaker, which may be separate from or integral to the electronic device. The input/output controller 1024 may also be configured to receive and process an input from one or more input devices 1026, for example, a keyboard, a microphone, or a touchpad. In one embodiment, the output device 1025 may also act as the input device. An example of such a device may be a touch sensitive display. The input/output controller 1024 may also output data to devices other than the output device, e.g. a locally connected printing device. In some embodiments, a user may provide input to the input device(s) 1026 and/or receive output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of secure metering, the method comprising:
obtaining a security token from a metering server in a hyperconverged infrastructure having primary storage and secondary storage;
accessing the secondary storage using the security token;
determining usage data for the secondary storage;
generating a first message digest for a combination of the usage data and the security token; and
transmitting, to the metering server, the usage data and the first message digest.

2. The method of claim 1, further comprising:
requesting, by the metering server, verification usage data from the secondary storage;
generating a second message digest for a combination of the verification usage data and the security token;
comparing the first message digest with the second message digest; and
based on at least the first message digest differing from the second message digest, generating an alert.

3. The method of claim 2, further comprising:
based on at least the first message digest matching the second message digest, using the usage data to adjust, by a machine learning (ML) model, a parameter of the secondary storage.

4. The method of claim 1, wherein accessing the secondary storage comprises moving data from the primary storage to the secondary storage, and wherein the primary storage comprises block storage and the secondary storage comprises an object storage service.

5. The method of claim 1, further comprising:
not persisting, at a customer premises, the security token.

6. The method of claim 1, wherein accessing the secondary storage using the security token comprises using the security token to encrypt data exchanged with the secondary storage.

7. The method of claim 1, wherein the combination of the usage data and the security token comprises a concatenation of the usage data and the security token.

8. The method of claim 1, further comprising:
based on at least a reboot of a management server, requesting, by the management server, the security token from the metering server;
based on at least a reboot of a first virtualization layer, requesting, by the first virtualization layer, the security token from the management server; and
based on at least a failure to receive the security token from the management server, requesting, by the first virtualization layer, the security token from a second virtualization layer.

9. A computer system comprising:
a processor; and
a non-transitory computer readable medium having stored thereon program code executable by the processor, the program code causing the processor to:
obtain a security token from a metering server in a hyperconverged infrastructure (HCI) having primary storage and secondary storage;
access the secondary storage using the security token;
determine usage data for the secondary storage;
generate a first message digest for a combination of the usage data and the security token; and
transmit, to the metering server, the usage data and the first message digest.

10. The computer system of claim 9, wherein the program code is further operative to;
request, by the metering server, verification usage data from the secondary storage;
generate a second message digest for a combination of the verification usage data and the security token;
compare the first message digest with the second message digest; and
based on at least the first message digest differing from the second message digest, generate an alert.

11. The computer system of claim 9, wherein accessing the secondary storage comprises moving data from the primary storage to the secondary storage, and wherein the primary storage comprises block storage and the secondary storage comprises an object storage service.

12. The computer system of claim 9, wherein the program code is further operative to;
not persist, at a customer premises, the security token.

13. The computer system of claim 9, wherein accessing the secondary storage using the security token comprises using the security token to encrypt data exchanged with the secondary storage.

14. The computer system of claim 9, wherein the combination of the usage data and the security token comprises a concatenation of the usage data and the security token.

15. The computer system of claim 9, wherein the program code is further operative to;
based on at least a reboot of a management server, request, by the management server, the security token from the metering server;
based on at least a reboot of a first virtualization layer, request, by the first virtualization layer, the security token from the management server; and
based on at least a failure to receive the security token from the management server, request, by the first virtualization layer, the security token from a second virtualization layer.

16. A non-transitory computer storage medium having stored thereon program code executable by a processor, the program code embodying a method comprising:
obtaining a security token from a metering server in a hyperconverged infrastructure (HCI) having primary storage and secondary storage;
accessing the secondary storage using the security token, wherein accessing the secondary storage comprises moving data from the primary storage to the secondary storage, and wherein the primary storage comprises block storage and the secondary storage comprises an object storage service;
determining usage data for the secondary storage;
generating a first message digest for a combination of the usage data and the security token; and
transmitting, to the metering server, the usage data and the first message digest.

17. The computer storage medium of claim 16, wherein the program code method further comprises:
requesting, by the metering server, verification usage data from the secondary storage;
generating a second message digest for a combination of the verification usage data and the security token;
comparing the first message digest with the second message digest; and
based on at least the first message digest differing from the second message digest, generating an alert.

18. The computer storage medium of claim 16, wherein accessing the secondary storage using the security token comprises using the security token to encrypt data exchanged with the secondary storage.

19. The computer storage medium of claim 16, wherein the combination of the usage data and the security token comprises a concatenation of the usage data and the security token.

20. The computer storage medium of claim 16, wherein the program code method further comprises:
based on at least a reboot of a first virtualization layer, requesting, by the first virtualization layer, the security token from a management server; and
based on at least a failure to receive the security token from the management server, requesting, by the first virtualization layer, the security token from a second virtualization layer.
